(19) United States
(12) Patent Application Publication
(10) Pub. No.: US 2010/0203493 A1
(43) Pub. Date: Aug. 12, 2010

(54) Learning component instructional software system and method

(76) Inventors: Per Anderson, Highland, UT (US); Thor Anderson, Highland, UT (US)

Correspondence Address: HARNESS, DICKEY & PIERCE, P.L.C., P.O. BOX 8910, RESTON, VA, 20195, US

(21) Appl. No.: 12/656,480

(22) Filed: Feb. 1, 2010

Related U.S. Application Data
(60) Provisional application No. 61/202,125, filed on Jan. 30, 2009.

(51) Int. Cl. G09B 7/00

(52) U.S. Cl. 434/362

(57) ABSTRACT

A learning component instruction development/design environment system is provided. The system includes; web servers operatively connected to communication and streaming media servers, application servers, a component and media repository and a database. The system is configured to perform one or more of the following methods; a method of editing a learning sequence in a computer based instructional development/design environment, a method of interacting with a learning sequence, and a method of analyzing a sequence session.

### CROSS-REFERENCE TO RELATED APPLICATIONS

This application claims priority to a Provisional U.S. patent application entitled, Learning Component Instructional Software System and Method, filed Jan. 30, 2009, having Ser. No. 61/202,125, the disclosure of which is hereby incorporated by reference in its entirety.

### FIELD OF THE INVENTION

The present invention relates generally to the field of instructional design and instructional software authoring and more particularly to a tool set and method for creation of computer-based instructional sequences comprised of discrete learning software components delivered over the Internet.

### BACKGROUND OF THE INVENTION

Many instructional authoring tools in the past have used pre-determined, pre-compiled “components” that authors could choose from to assemble instruction. However, authors themselves may desire to create custom learning components rather than choose from a limited, pre-compiled set. In addition, the need may arise for custom instructional sequence assembly and monitoring within a software architecture designed to enhance learning that is delivered over the Internet.

### SUMMARY OF THE INVENTION

Embodiments of the invention relate to methods and apparatuses for one or more of the following: editing a learning sequence in an instructional development/design environment, interacting with a learning sequence, analyzing a sequence session, and a learning component instruction development/design environment system.

In one embodiment, a method of editing a learning sequence in a computer based instructional development/design environment is provided. The method includes; adding a learning activity to the learning sequence, arranging the learning activity in a sequence graph, adding rules to the sequence graph, deploying the sequence, and creating a sequence session.

In another embodiment a method of interacting with a learning sequence is provided. The method includes; launching learning components on a computer, logging into a system, adding a learner tracking strip to live monitor a learner, notifying an instructor that a learner is active, loading a learning activity in a sequence, loading a parent learning component for a current activity, displaying the components user interface for the current activity, presenting instructions to the learner for the current activity, tracking results of the current activity, interacting with the component's interface, evaluating the interactions, updating at least one of the learner's progress and performance on the current activity, providing feedback to the learner regarding at least one of the learner's progress and performance on the current activity, determining if the learner has completed the current activity, and sending results the learner's performance of the current activity to a database.

In another embodiment, a method of analyzing a sequence session is provided. The method includes; selecting a sequence session to analyze, loading a results monitor on a computer, retrieving learning components employed in the sequence, loading a component monitor associated with the learning components, loading a component monitor user interface, displaying activity results collected by the learning activities, and displaying a list of learners and comparing results associated with a learner.

Another embodiment includes a learning component instruction development/design environment system. The system includes; web servers operatively connected to communication and streaming media servers, application servers, a component and media repository and a database wherein the system is configured to: launch learning components on a computer, add a learner tracking strip to live monitor a learner, notify an instructor that a learner is active, load a learning activity in a sequence, load a parent learning component for a current activity, display the components user interface for the current activity, present instructions to the learner for the current activity, track results of the current activity, interact with the component's interface, evaluate the interactions, update at least one of the learner's progress and performance on the current activity, provide feedback to the learner regarding at least one of the learner's progress and performance on the current activity, determine if the learner has completed the current activity, and send results the learner's performance of the current activity to a database.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a basic diagram of the main hardware and technology used to host the software service as well as the three main user roles.

FIG. 2 is a diagram depicting the structure of a learning component.

FIG. 3 is a diagram depicting the structure of a component monitor.

FIG. 4 is a diagram of a rule set.

FIG. 5 is a diagram of a learning sequence which contains both learning activities and rule sets.

FIG. 6 illustrates the IDE (instructional development/design environment).

FIG. 7 illustrates the live, real-time feedback presented to the instructor while the learner interacts with the learning sequence, communication options, instructional triage and the option to “inject” a sub-sequence altering the sequence for a learner or a group of learners at run-time.

FIG. 8 illustrates the dashboard for visualizing activity results (data) recorded by the player and a component monitor loaded in the dashboard.

FIG. 9 illustrates the learning components (LC) player.

FIG. 10 is a flow chart illustrating how an instructor may create or edit a learning sequence.

FIGS. 11a and 11b are a flow chart illustrating how a learner may interact with a learning sequence with instructor intervention.

FIG. 12 is a flow chart illustrating how an instructor may interact with the dashboard.

### DETAILED DESCRIPTION OF EXAMPLE EMBODIMENTS

Various example embodiments will now be described more fully with reference to the accompanying drawings in which some example embodiments are illustrated.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be rearranged. The processes may be terminated when their operations are completed, but may also have additional steps not included in the figures. The processes may correspond to methods, functions, procedures, subroutines, subprograms, and other similar elements.

The methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. As used herein, the term “and/or” includes any and all combinations of one or more of the associated listed items.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the present invention and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Example embodiments will now be described with like numbers referring to like parts.

### Overview of Example Embodiments

The architecture, tools, and methods overview of Example Embodiments described herein will appeal to educators who need to create custom, computer-based instruction that can be monitored in real-time, provide immediate, visual feedback to learners on each learning activity, and be delivered over the Internet. The architecture, tools and methods of the invention are agnostic with regards to instructional theory or approach to be used allowing for great instructional flexibility. They are also agnostic with regards to the content or subject matter being taught to allow for complete flexibility across a curriculum.

The architecture of some embodiments of the invention rely, at least in part, upon web servers, application servers, streaming media servers, messaging servers, a database, and content repository, and software classes and interfaces written in the ActionScript programming language. The flexibility of the software architecture allows for authors to create custom learning components that can be significantly customized to achieve specific instructional goals. The learning components IDE 600 may be a primary tool used by instructional designers to customize the instructional sequence, the learning component properties, learning activity properties, and the learner performance monitoring capabilities.

Learners will benefit from interacting with the learning components player tool 900 primarily because the player provides a consistent method for interaction with the learner. The learner's feedback is visually represented 906 with progress bars and there is also the possibility for real-time communication with the instructor via text chat, video conferencing, whiteboard, remote screen viewing/sharing and other real time communication methods. In addition, the instructor is able to “inject” an additional sub-sequence into the currently executing sequence if the instructor notices students struggling with the sequence or has some other reason to interrupt the sequence with additional instructional materials. While many different learning theories can be implemented within the disclosed system, research has shown that learners almost always benefit from timely, explanatory feedback such as the player provides.

Well-designed instruction can consist of many conditional statements that need to be evaluated in order to provide an optimal learning experience. The system provides for such conditions through the use of rule set components 400. Due to the system software architecture, the rule set component is able to recognize (via a software process called introspection) the properties of each learning activity 202 and present a rules configuration editor allowing the author to highly customize the desired instructional interaction.

A component developer 102 will use the published application programming interface (API) of the invention to create individual learning components 200. Component developers are able to set a price for the use of their components or opt to participate in a revenue pool where a percent of revenue is set aside to pay developers based on the popularity of their components if they choose to offer said component for free to the community. This could lead to the system serving as a marketplace for instructional components. This would be a unique and welcome development in the field of instructional authoring tools. Another advantage of the API is that a variety of additional authoring tools and playback environments could be developed that could make use of the learning components. This is because the API may keep the individual learning components from being written in a manner that ties them to the learning component IDE 600 or learning component player 900.

The advantages, utility, and novel features of the invention will become more apparent from the following detailed description of a preferred embodiment.

Description of Example Embodiments

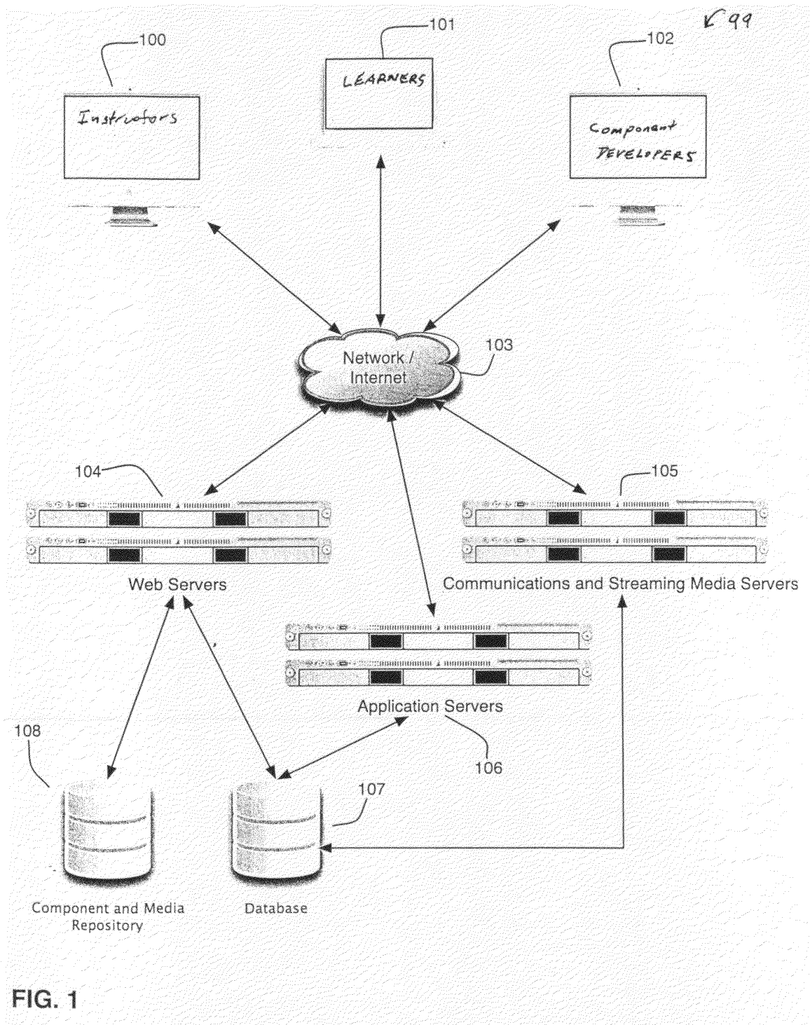

Referring now to the drawings, wherein like reference numerals and characters represent like or corresponding parts and steps throughout each of the many views, there is shown in FIG. 1 a diagram of the LC (learning components) system 99 in accordance with an embodiment. The hardware and software delivery systems can be broken into three groups as depicted in FIG. 1: web servers 104, application servers 106 and communications and streaming media servers 105. The web servers 104 access the database 107 and repository 108 to deliver web pages, the IDE 600, the player 900 and learning components 200. The application servers 106 read and write objects and their data to and from the database 107. The communications and streaming servers 105 handle communications between the instructor 100 and learners 101 as well as transmit application specific messages between the IDE 600 and player 900.

The system is provided as a service over a network or the internet 103 and has three main users of the LC system: instructors 100, learners 101 and component developers 103. Learners 101 use the system 99 to learn concepts taught on the system 99. Instructors 100, among other things, monitor the learners 101 and provide assistance for the learners 101. Component developers 103 contribute learning components 200, component monitors 300 and example learning sequences 500.

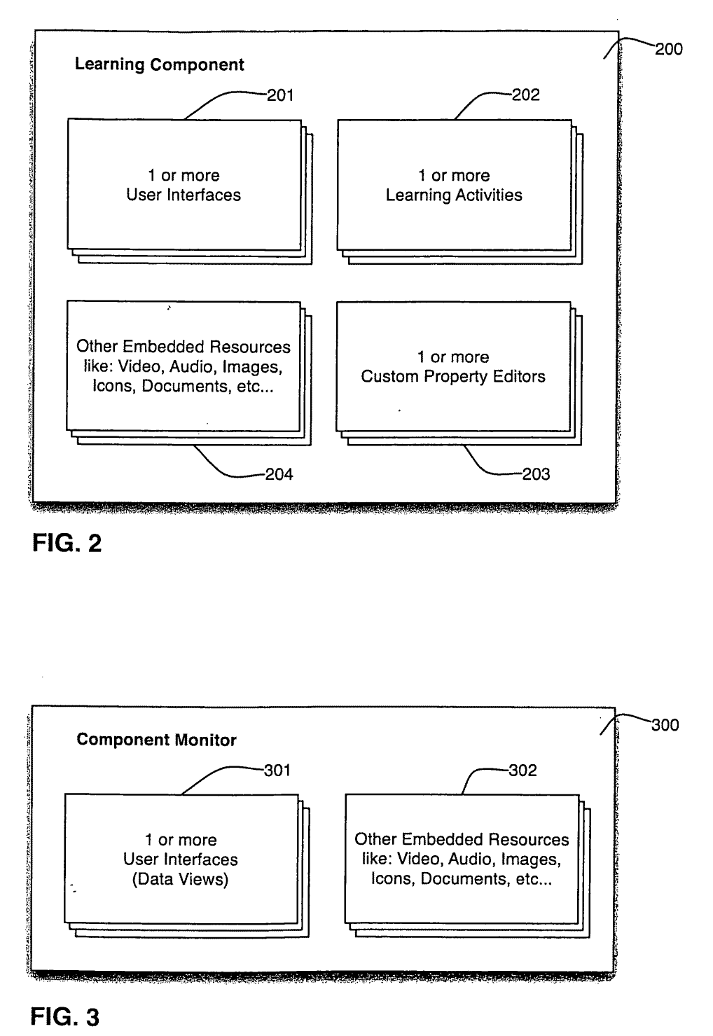

As shown in FIG. 2, a learning component 200 may include several things. A learning component 200 may be defined as an application or module packaged into a single file containing all necessary resources and one or more learning activities 202. A learning activity 202 is an object that can be configured by an instructor 100 at design-time and process learner 101 interactions at run-time to determine the learner's progress. The learning component 200 may also include other embedded resources 204 such as video, audio, images, icons, documents and the like to be used with or part of learning activities 202. The learning component may also include one or more custom property editors 203. The custom property editor 203 may allow the learning activities 202 to be edited. In some embodiments, the custom property editor 203 may allow the learning component 200 to be edited.

The custom property editor 203 is any MXML component compiled and distributed with the learning component 200. The developer decides how he/she prefers to implement the custom property editor 203. All user interfaces (UI) 201, the learning component 204 icon and, all learning activities 202 and their icons 204, all custom property editors 203 and any other embedded resources 204 are embedded and distributed within the compiled (“Small Web Format”) SWF file. The resulting SWF file constitutes a learning component 200.

As shown in FIG. 3 a component monitor 300 is another type of application or module that provides data visualization for a given learning component 200. The component monitor 300 may include 1 or more user interfaces (data views) 301. The component monitor 300 may also include other embedded resources 302 like video, audio, images, icons, documents, and the like.

Optionally a component developer 103 may choose to also develop a component monitor 300 to accompany his/her learning component 200. For example, in one example embodiment, a component monitor 300 may be an Adobe flex module that implements the com.learningcomponents.IComponentMonitor interface. Its purpose is to visualize data stored by the developer independent of the LC system. One or more component monitors 300 can be associated with a learning component 200. A component monitor 300 supplies a user interface 301 for visualizing the data. It may include other embedded resources 302 and is compiled into a single SWF file.

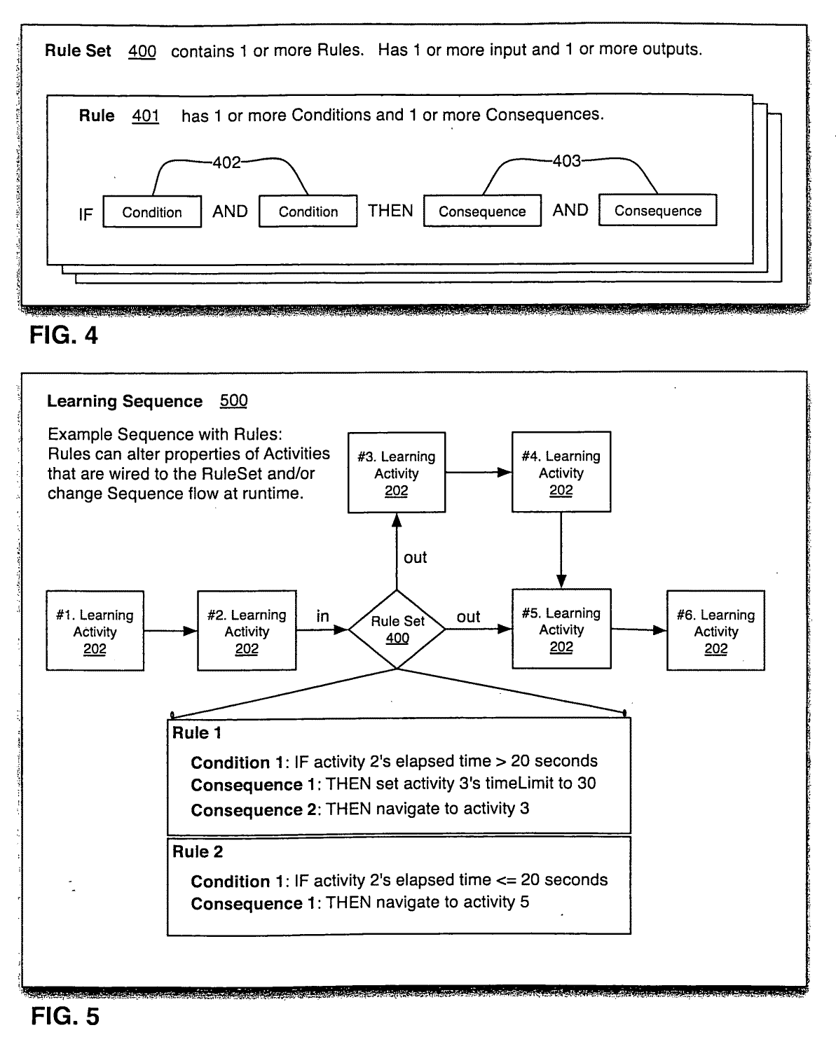

FIG. 4 shows an example rules set 400. A rule set 400 contains one or more rules 401 that can be configured at design-time to alter the properties of learning activities 202 in the sequence at run-time and may also alter the order of activities that appear next in the sequence. A rule set 400 is also a container for one or more rules 401. A rule 401 has one or more conditions 402 and one or more consequences 403. If all of the conditions 402 are met then each of the consequences 403 will operate or fire. This could result in one or more learning activity's 202 properties being modified and eventually the learner 101 routed to the next learning activity 202.

FIG. 5 illustrates a learning sequence 500. A learning sequence 500 contains a map of interconnected learning activities 202 and rule sets 400. The learning sequence 500 as shown in FIG. 5 includes an example of various learning activities 202 and a rule set 400 with example rules, conditions and consequences.

The system 99 provides the ability to assemble, edit and maintain a learning sequence 500 containing learning activities 202 and rule sets 400 via an IDE (instructional design/development environment) 600 and playback of those learning sequences 500.

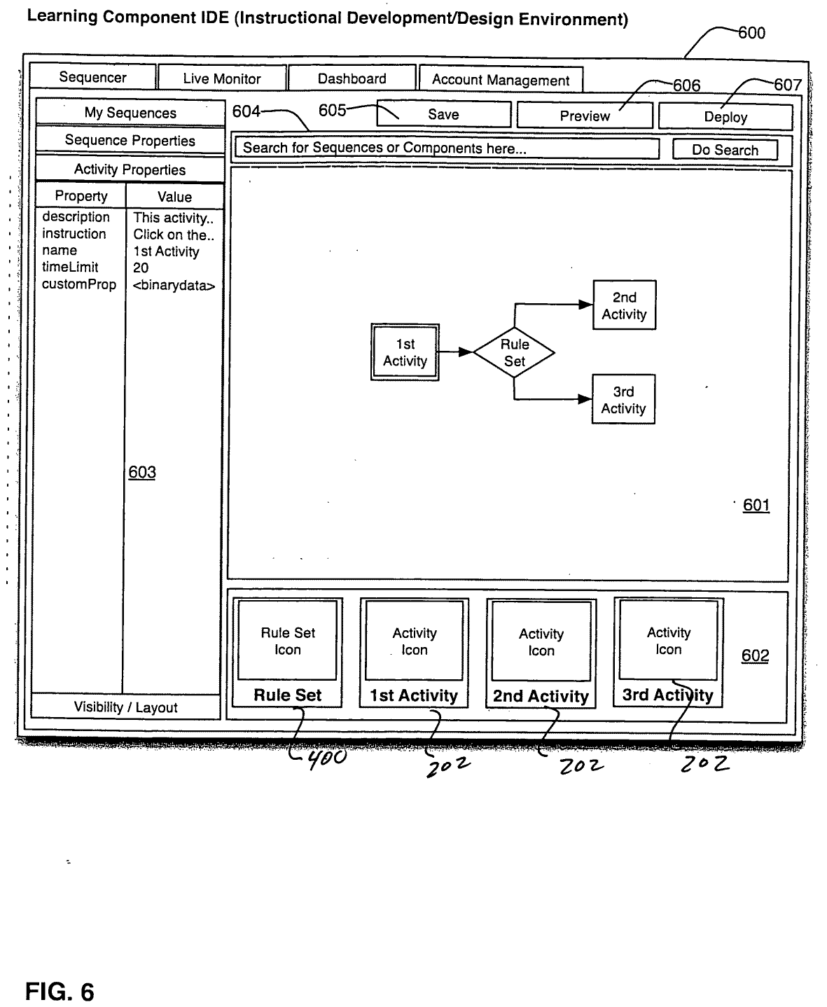

As shown in FIG. 6, the IDE 600 provides a sequencer to assemble or “wire/link” learning activities 202 and rule sets 400 together into a learning sequence 500, a mechanism to monitor, manipulate or intervene in the learner's interaction with learning sequences 500 in real-time.

The IDE 600 includes a sequence graph 601 for displaying a learning sequence 500. An activity palette 602 may include rule sets 400 and learning activities 202 that may be dragged and dropped into the sequence graph 601 to edit the learning sequence 500. The property editor 603 allows editing of the learning sequence 500. The search area 604 allows an instructor 100 to search for existing learning sequences 500 created and shared by other instructors or to search for shared learning components 200 that contain learning activities 202 that may be of interest to the instructor 100. When searching for learning sequences 500, the results may be a list of potential sequences that the instructor 100 could choose from as a “template” or starting place for his or her own sequence. Selecting a shared sequence from the results creates a copy for that instructor 100 to freely manipulate and load that copy of the learning sequence 500 into the sequence graph 601. When searching for learning components 200 and their activities 202, the results may list learning components 200 that contain learning activities 202 that could be useful to the instructor 100. The instructor 100 could then select a learning component 200 from that list and choose to add that learning component's bundled learning activities 202 to his/her palette at which point he/she could drag and drop the activity onto the sequence graph 601.

The IDE 600 permits the edited learning sequence 500 (or sequence graph 601) to be saved. The edited sequence 601 may be previewed by running the preview function 606. The edited sequence may be deployed by running the deploy function 607.

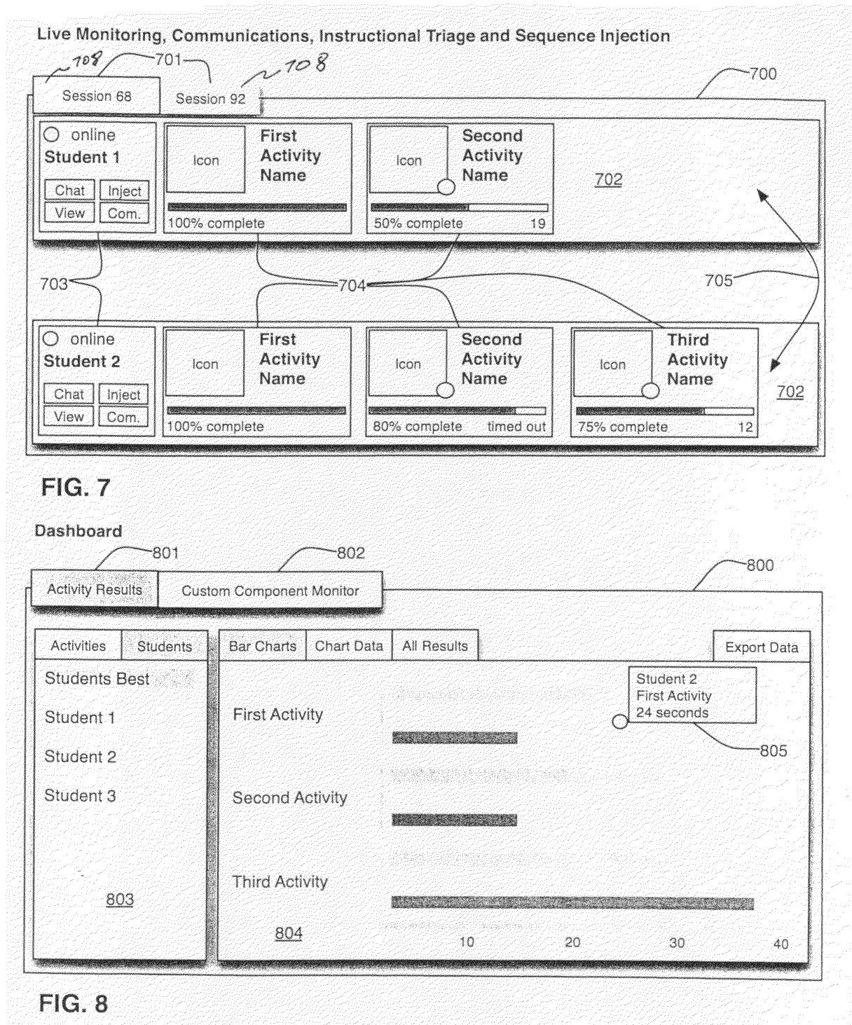

FIG. 7 shows an example of live monitoring, communication, instructional triage and sequence injection 700 available to an instructor 100 in accordance with some embodiments. The instructor 100 can select which session tab 708 to review with the live monitor 701. The live monitor may add a tracking strip 702. At any point during live monitoring the instructor 100 can interact with individual learners 101 or learners as a group. If, for example, the instructor 100 opted to turn on “instructional triage” 705, the live monitor 701 would calculate which learners 101 are struggling and automatically place their tracking strip 702 at the top of the list 705. The instructor 100 could then initiate communication 703 with the learner 101 and view the learner's screen to understand where the learner 101 is having issues. The instructor 100 could then assemble or have pre-assembled sequences 500 to help reinforce the lesson objective and then opt to “inject” 703 one or more of those sub-sequences into the currently executing sequence, altering the course of the sequence for this learner or group of learners. The sub-sequence is inserted immediately after the currently executing learning activity 202. Once the learner 101 completes, aborts or times out of the current activity 202, the first activity in the sub-sequence will execute.

As shown in FIG. 8, a dashboard 800 may be used to visualize the results of a student's interaction with a sequence, a library/repository 108 to search for and assess learning components 200, the ability to make modifications to his/her account as well as the ability to communicate with learners 101 and colleagues via instant messaging (chat), video/audio conferencing, whiteboard, and screen viewing/sharing. The custom component monitor 802 allows the instructor 100 to monitor learners 101. The learners 101 may be listed on a list 803 for the instructor 100 review. The performance of various activities may also be shown in a performance area 804. Special performance metrics 805 may be selected and listed for a second area 805.

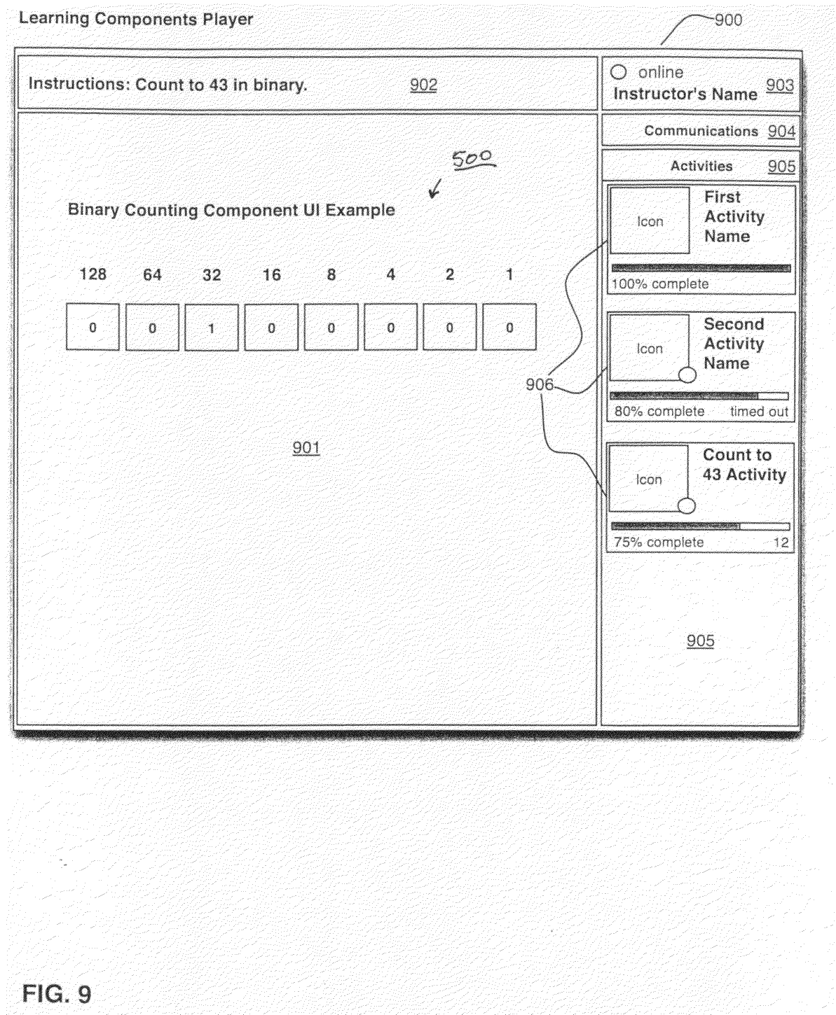

As shown, in FIG. 9, the player 900 provides a shell 901 to playback learning sequences 500, a way to communicate 904 with the instructor via instant messaging (chat), video/audio conferencing, whiteboard or screen viewing/sharing and the ability to record the learner's interactions with the learning sequence 500. Data is persisted in a relational database 107 and components are stored within a repository or file system 108.

An important feature of the LC system is an API (application programming interface) providing the vehicle to develop interoperable learning components 200 based on software such as, for example, Adobe's flex module component. A learning component 200 is a flex module that implements the com.learningcomponents.ILearningComponent interface and is compiled into a single SWF file. A learning component 200 has one or more learning activities 202 distributed along with it and provides the user interface “UI” or “views” 201 for those activities. A learning activity 202 is an ActionScript Class that extends the com.learningcomponents.LearningActivity super class which then extends com.learningcomponents.SequenceNode super class, both of which are found in the API.

Its public properties are exposed to the IDE's Property Editor 603, allowing them to be edited at design time. Those same properties are also exposed to the player 900 upon playback where they may be modified by rules 401 at runtime. A developer 102 may choose to hide properties or functions from the IDE's property editor 603 or from the IDE's rules editor by adding either a [hidefromeditor] annotation or a [hidefromrules] annotation above the property or function. Sometimes a learning activity's properties require a custom property editor 203.

A component monitor 300 is loaded into the dashboard 800 whenever an instructor 100 attempts to load a session 708 for viewing that is associated with a learning sequence 500, and that sequence references learning components 200 that have component monitors 300 associated with them.

A rule set 400 is an ActionScript class that, like a learning activity, extends com.learningcomponents.SequenceNode. Therefore learning activities 202 and Rule Sets 400 can be placed on a sequence graph 601 and wired/linked together (see FIG. 5). Both can have multiple inputs but only a rule set 400 can have multiple outcomes or outputs as shown in FIG. 5.

A learning sequence 500 contains instances of learning activities 202 and rule sets 400. It maintains the design-time state of each learning activity 202 and rule set 400 in the learning sequence 500 including its position in a sequence graph 601 and to whom it is wired. Each learning activity 202 instance maintains a URL reference to it's parent learning component 200 in the repository 108 so that when initially loading a learning sequence 500, the parent learning components 200 for all the learning activities 202 can be retrieved from the repository 108 and loaded into either the IDE 600 or the player 900 depending on which application is opening the learning sequence 500.

The concepts listed here and throughout this document are not limited to the Adobe Flex language. Various components of the system including the API, IDE and player may be developed in Java leveraging the .jar packaging method to bundle the Java resources into Java-based learning components. JavaBean technology allows design-time editing of Java based learning activities. A standardized packaging method is used (for example, .swf, .jar, .zip or others, and an API in a given language where a component provides a UI and provides activities that can be configured at design-time, manipulated by rules at run-time and process user events to determine if the activity, for example, has been aborted, timed out or completed. These components are then reusable within compatible applications.

As shown in FIG. 6, the IDE 600 provides a sequencer in the form of a graph 601, the live monitor 700, a dashboard 800 and account and file management. The instructor 100 logs into the IDE 600 and is presented with a sequence graph 601. At this point an instructor 100 could create a new sequence, open one of his/her own existing sequences or search 604 for a shared sequence. In a shared sequence, the instructor 100 may be given the option to get a copy and modify the sequence then save it under the instructor's 100 account. In either case an instructor 100 will likely need to add additional learning activities 202 to the learning sequence 500. The instructor 100 would search 604 for learning components using keywords/phrases. Results ranked by relevance are presented.

After selecting a component from the returned results, the instructor 100 can opt to add the learning component's learning activities to a palette 602. This action places an instance of all learning activities distributed with the learning component 200 into the activity palette 602 represented by an icon for each activity.

A learning component 200 acts as a learning activity 202 factory. The instructor 100 then can drag and drop activities onto the sequence graph 601. Selecting a learning activity 202 in the sequence exposes it's public properties to the instructor 100 where he/she can modify them with a properties editor 603. When an instructor 100 attempts to edit a property, the learning activity 202 checks to see if a generic property editor is to be used for that property or if the component developer has specified and included a custom property editor 203 for that particular property. The instructor 100 may then repeat the process adding more learning activities 202, wiring those activities together and modifying their properties.

Sometimes the instructor 100 may wish to have the learning sequence 500 adapt at run-time to the learner who is interacting with the sequence 500. In this case a rule set 400 would be added to the sequence by dragging and dropping the rule set 400 from the activity palette 602 onto the sequence graph 601 and proceed to add and edit rules 401 within the rule set 400 as shown in FIG. 5.

A rule set 400 is available within the activity palette 602 represented by an icon. Saving 605 the sequence graph 601 serializes the learning sequence 500 to the database 107 capturing the design-time state of each learning activity 202 and rule set 400 in the learning sequence 500. Next the instructor would preview 606 the sequence in the LC player 900.

Once the sequence 500 has been tested the instructor 100 would deploy 607 the sequence 500 creating a unique sequence session. The system 99 then presents the instructor 100 with a hyperlink to the sequence session which he/she may place in a web page or email to learners 101.

Once a learning sequence 500 has been deployed, learners 101 can access the sequence via the LC player 900 by the unique session ID. Once the learner 101 has been authenticated, the player shell 901 as shown in FIG. 9 appears in the background. The system 99 notifies the instructor 100 that a learner for that unique session has logged into the player 900 by adding a new session tab 708, if not already present, to the live monitor 701.

The live monitor then adds a tracking strip 702 for that learner 101 and indicates that the learner 101 is “online” 703. The instructor's online status appears 903 and the first indication of a learning activity 202 appears in the “activities” panel 905.

The player 900 loads the activity's parent learning component 200 and displays the appropriate user interface or “view” 201 based on the currently loaded learning activity 202. The first instructions appear both in the instruction bar 902 and in an instruction dialog. When the learner 101 dismisses the instruction dialog, the learning sequence 500 begins.

As the learner 101 interacts with the UI 201, those events are processed by the learning activity 202 and it determines how much of the activity has been completed. This information is relayed back to both the instructor 100 and the learner 101 by a visual representation 704 and 906 of the activity. Progress and status is reported via progress bars and text. Even an icon representing the learning activity can change to indicate if the activity is, for example, time sensitive and the like. Both the learner 101 and instructor 100 will receive progress updates 906 and 704 upon each processed event until the learning activity is completed, aborted or timed out.

At the completion of each learning activity 202, the player 900 submits the activity results to the database 107 for later viewing within the dashboard 800. This process is repeated until all learning activities 202 in the learning sequence 500 have executed. With the sequence complete, the learner 101 can simply close their browser or if the learning sequence's 500 “freeplay” property was set to “true” then the learner is allowed to click on any of the activities listed 905 to further “practice” with that activity. Because the sequence is finished, interactions with the activities at this point are no longer broadcast or recorded.

With the learner 101 finished with the session 708, the instructor 100 can go back at any time and view the results of a session 708 through the dashboard 800 by selecting a session 708 listed in a pulldown or select from a list of sessions. The dashboard 800 loads the activity results monitor 801 which helps visualize the data returned from all learning activities 202 such as elapsed time, whether or not the activity timed out or was aborted. It also has a number of ways to view session 708 averages as well as compare individual performances visually.

The activity results monitor 800 provides a raw data view and the ability to export the raw data in a variety of exchangeable formats. At any time, the instructor 100 can request a refresh of the data. Not every performance metric may be anticipated, especially considering that learning components 200 and learning activities 202 are unique to the component developer 103 and independent of the IDE 600 and player 900. The component developer 103 may choose to have his/her learning component 200 and/or learning activities 202 record learner 101 interaction data to their own data store. This may not be very useful to the instructor 101 unless there is a way to display or visualize that data. This is where a component monitor 300 (or two) make for a useful companion to a data driven learning component 200.

When accessing data for a session 708 within the dashboard 800, the activity results monitor 801 appears but other tabs as illustrated in FIG. 8 may also appear. If within the sequence there exists a learning component 200 that has one or more component monitors 300 associated with it, those component monitors 300 will be loaded into their own tab within the dashboard 800. Where the component monitor 300 gets its data, what options are available to the instructor 100 and how its data is displayed will be determined the component developer 103.

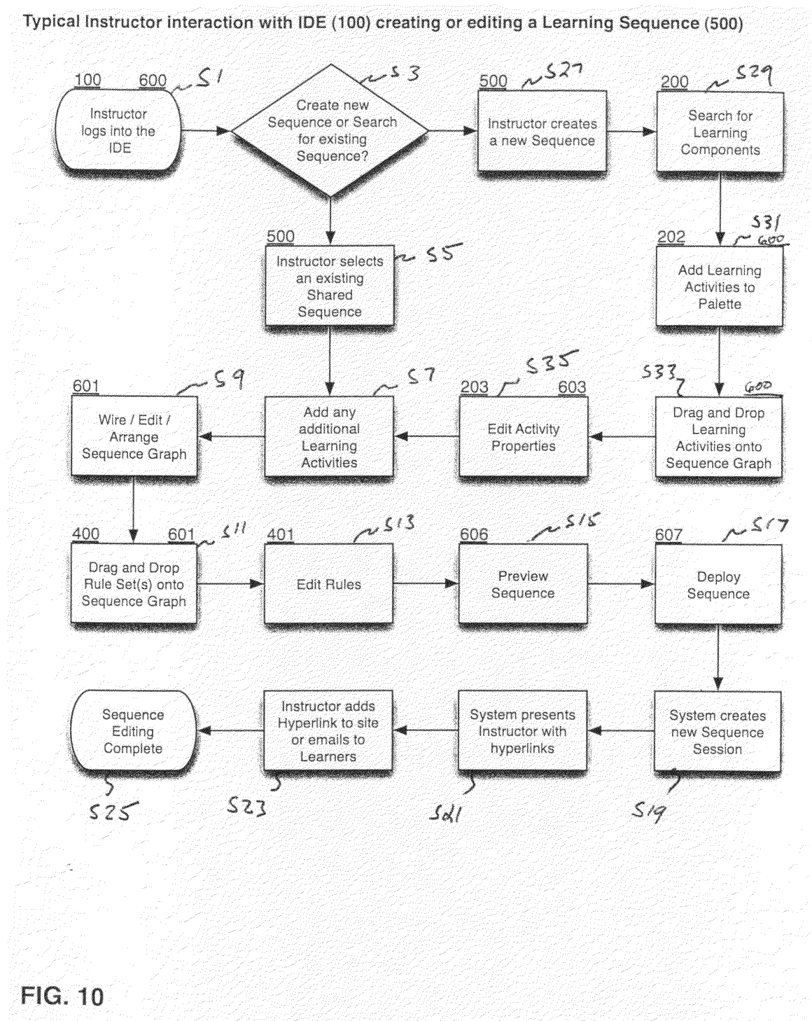

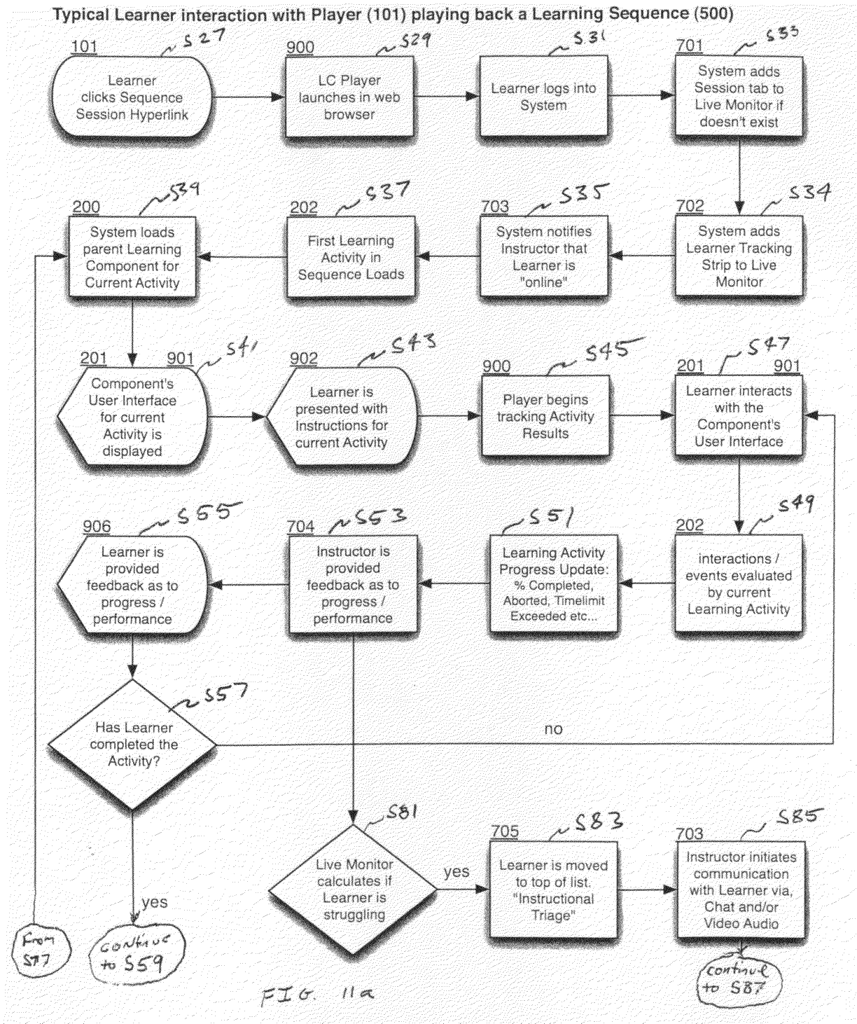

The flow charts shown in FIGS. 10-12 and described below summarize methods described above.

FIG. 10 illustrates a flow chart showing a typical instructor interaction with an instructional development/design environment (IDE) to create or edit a learning sequence in accordance with an example embodiment of the invention. The various steps are labeled with an S preceding a number. As shown in FIGS. 10-12 many of the various steps also have underlined three digit numbers located near the step boxes. These numbers indicate various components shown in FIGS. 1-9 that may be used to accomplish the steps. The three digit numbers are not an exhaustive list of the features used to accomplish the step but are useful as a guide.

As shown in FIG. 10 in the first step S1, the instructor logs into the IDE. In step S3 the instructor decides whether to create a new sequence or search for an existing sequence. If the instructor decides to search for an existing sequence, at step S5 the instructor selects an existing shared sequence uncovered in the search. At step S7 the instructor adds any additional learning activities the instructor desires to add to the sequence. At step S9 the instructor wires, edits, or arranges the sequence graph. In step S11 the instructor may insert a rule set into the sequence path. In some embodiments the instructor may need only to drag and drop a rule set into the sequence graph.

At step S13 the instructor may edit the rules. In step S15 the instructor may preview the sequence that has been edited. At step S17 the instructor may deploy the sequence. At step S19 the system creates a new sequence session. At step S21 the system presents the instructor with a hyperlink to the newly created sequence session. At step S23 the instructor adds a hyperlink to the newly edited or created session to a website or e-mails the hyperlink to learners. At step S25 the sequence editing session is complete.

Returning to S3, if the instructor decides to create a new sequence instead of merely editing an existing sequence, at S27 the instructor opens or creates a new sequence. At step S29 the instructor searches for learning components. At step S31 the instructor adds learning activities found in the search for learning components to a palette. At step S33 the instructor may insert learning activities onto the sequence graph. In some embodiments, the learning activities may be dragged from a palette to the sequence graph. At step S35 the instructor may edit the activity properties. From step S35, the method proceeds to step S7 and the remainder of the steps as previously described above.

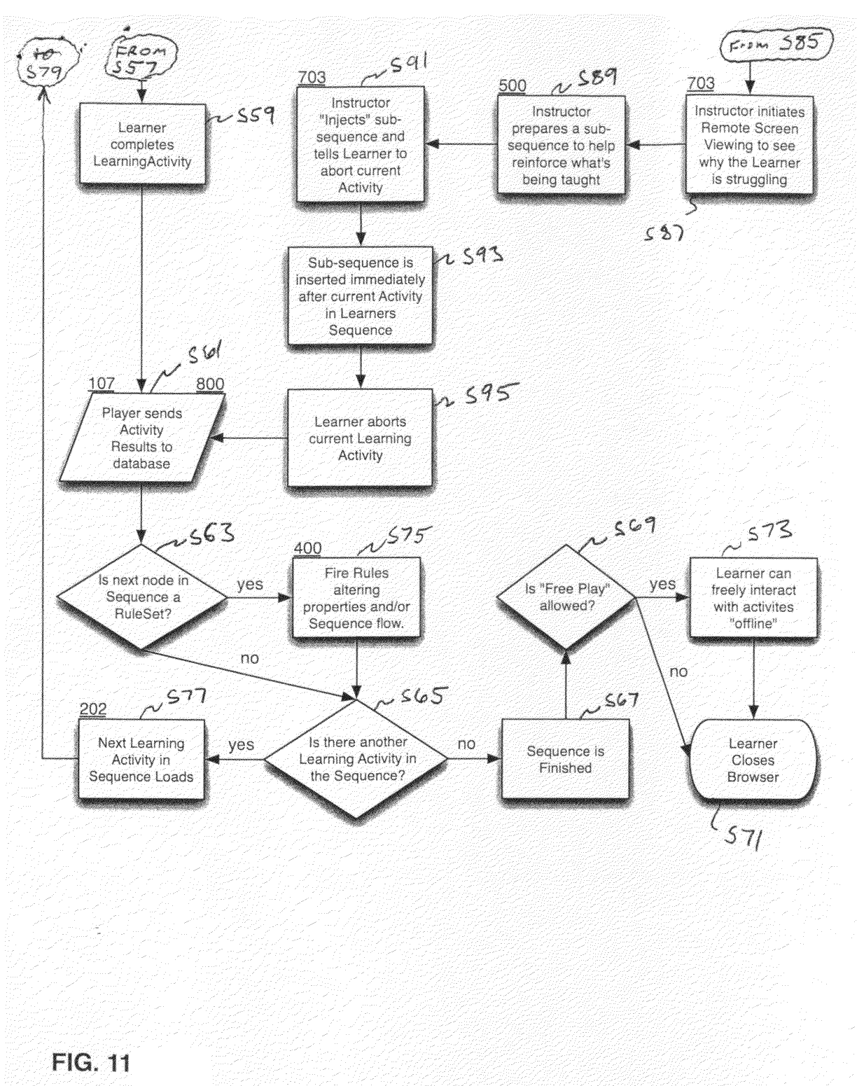

FIGS. 11a and 11b show a single flow chart that represents a typical learner interaction with a player playing back a learning sequence in accordance with an embodiment of the invention.

The learner may begin to interact with a player to playback a learning sequence by clicking on a sequence session hyperlink as shown in S27. Clicking on the hyperlink may cause the learning component player to launch in a web browser as indicated in S29. In step S31 learner may log into the system. In step S33 the system adds a session tab to the live monitor if one does not already exist. In step S34 the system adds the learner's the tracking strip to a live monitor. In step S35 the system notifies the instructor that the learner is now “online.” In step S37 a first learning activity in a sequence loads. At step S39 the system loads a parent learning component for the current activity that will be interacted with by the learner. At step S41 the component user interface for the current activity is displayed to the learner. At step S43 the learner is provided with instructions for the current activity.

At step S45 the player begins to track activity results. The activity results may include, but are not limited to, the time it takes for the player to accomplish learning tasks and whether the learner is correctly responding to the current activity. At step S47 the learner interacts with the component's user interface. At step S49 the learner's interactions and events are evaluated by the current learning activity. Step S51 learning activity progress is updated. For example, the update may include how complete the current activity is, whether the activity has been aborted, whether a time limit is exceeded, and/or other learning activity progress may be tracked.

At step S53 the instructor is provided with feedback as to the progress and/or performance of the learner. Assuming the learner is making satisfactory progress, at step S55 the learner is provided with feedback as to the learner's progress and/or performance. At step S57 the system determines whether the learner has completed the activity. If the learner has completed the activity, as indicated by S59 shown in FIG. 11B, the player sends activity results to a database as indicated in S61. In step S63 it is determined whether the next node in a sequence is a rule set, if not, the system determines at step S65 whether there is another learning activity in the sequence. If there is not, the sequence is finished as indicated in step S67.

Once a sequence is finished, the system may determine whether free play is allowed in S69. Free play may permit a learner to work on or complete additional activities that may not be monitored by an instructor and the results may not be saved in the database. Once it is determined whether free play is allowed in S69 the learner can freely interact with additional activities offline as indicated in S73 after which the learner may close the browser in S71. If free play is not permitted, then the learner may directly go to step S71 and close the browser.

Returning to step S63, if the next node in the sequence is a rule set then, as indicated in step S75, the rules may execute or “fire” altering the properties and/or flow of the sequence. Once step S75 has been completed the system returns to step S65. At step S65, if it is determined that there is another learning activity in the sequence then at step S77 the next learning activity in the sequence loads. Once step S77 has been completed, the system returns to step S39 where the system loads the parent learning component for the current activity. The method then proceeds as described above.

Returning to step S53, if it is determined that the learner is struggling as indicated in step S81 then at step S83 the learner is moved to a top of a “instructional triage” list. The instructor can see that the learner is struggling as listed on the instructional triage list. At step S85 the instructor initiates communication with the learner. Communication can be via chat or audio visual, e-mail or any other suitable means of communicating with the learner.

At step S87 the instructor can initiate remote screen viewing to see what the learner is doing and determine why the learner is struggling. At step S89 the instructor may prepare a subsequence to help reinforce what's being taught. At step S91 the instructor may inject the subsequence and instruct the learner to abort the current activity in favor of the subsequence. At step S93 the subsequence is inserted after the current activity in the learner sequence. At step S95 the learner aborts the current learning activity and works on the subsequence. After the learner has aborted the current learning activity the player sends activity results to the database as indicated in step S61. The method then proceeds as discussed above from step S61.

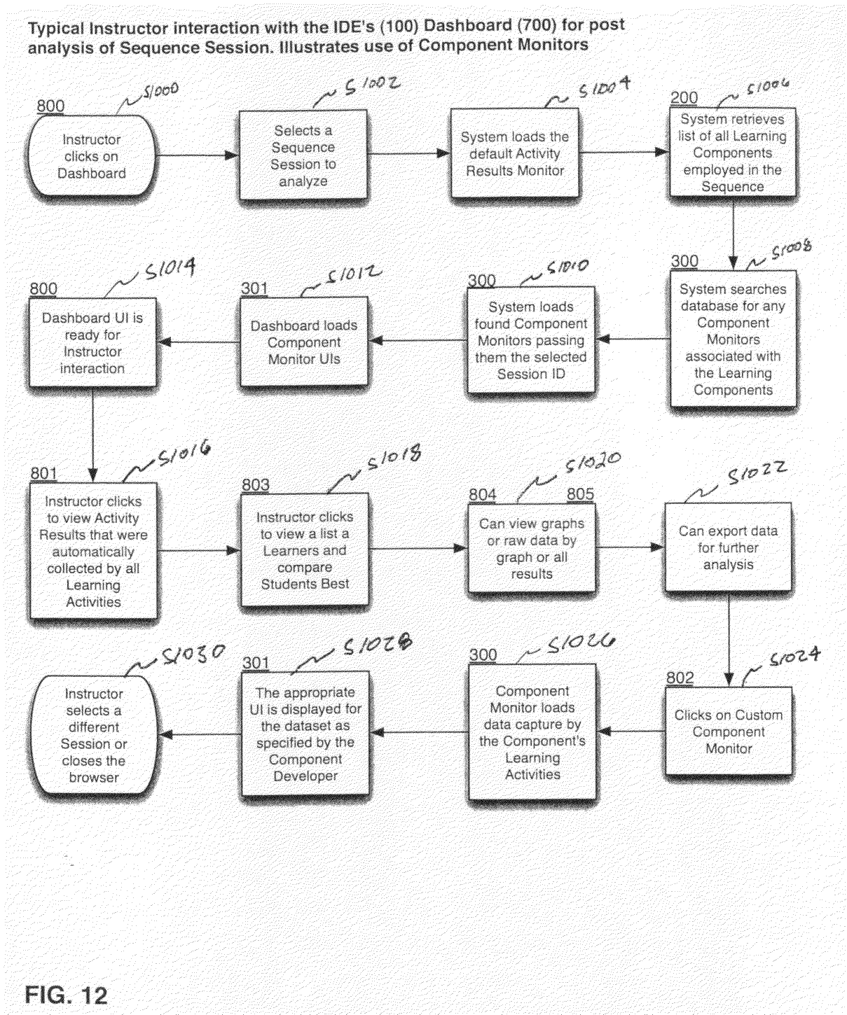

FIG. 12 illustrates an example method in accordance with another embodiment of the invention. It illustrates a typical instructor interaction with the IDE's and dashboard for post analysis of a sequence session. FIG. 12 also illustrates the use of component monitors in accordance with some embodiments of the invention. To start the method, the instructor may click on the dashboard at step S1000. At step S1002 the instructor may select a sequence session to analyze. At step 1004 the system loads a default activity results monitor. At step 1006 the system retrieves a list of all learning components employed in the sequence. At step 1008 the system searches the database for any component monitors associated with the learning components. At step 1010 the system loads component monitors found in the search and passes them the selected session ID. When the instructor selects a session to review, the default activity monitor loads and then any component monitors that are associated with any learning components that are referenced by the sequence. The system then passes a session ID to the component monitors so that the monitors know as to which session they are to retrieve data for display. At step S1012 the dashboard loads the component monitors user interfaces. At step 1014 the dashboard user interface is ready for instructor interaction.

At step S1016 the instructor may click to view activity results that were automatically collected by all learning activities. At step S1018 the instructor may click to view a list of learners and compare the student's (learner's) results. In some embodiments the learner's best results are compared. At step 1020 the instructor can view graphs or raw data or all results of the learners learning activities. At step S1022 the data can be exported for further analysis.

At step S1024 instructor may click on a custom component monitor. At step S1026 the component monitor may load data captured by the components learning activities. At step S1028 the appropriate user interface is displayed for the data set as specified by the component developer. At step S1030 the instructor may select a different session to analyze which would bring the instructor back to step S1004 and proceed with the method as described above, otherwise, the instructor may close the browser ending the method.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of editing a learning sequence in a computer based instructional development/design environment comprising:
adding a learning activity to the learning sequence;
arranging the learning activity in a sequence graph;
adding rules to the sequence graph;
deploying the sequence; and
creating a sequence session.

2. The method of claim 1 further including:
editing the rules.

3. The method of claim 1 further including:
searching for an existing learning sequence; and
selecting an existing learning sequence from the search results, wherein the learning activity is added to the selected learning sequence.

4. The method of claim 1 further including:
at least one of: a) emailing the created sequence session to a learner and b) presenting an instructor with a hyperlink to the created sequence session.

5. The method of claim 1 wherein the learning sequence is created by
searching for learning components;
adding learning activities from results of the search to a sequence graph; and
editing the learning activity properties.

6. A method of interacting with a learning sequence comprising:
launching learning components on a computer;
logging into a system;
adding a learner tracking strip to live monitor a learner;
notifying an instructor that a learner is active;
loading a learning activity in a sequence;
loading a parent learning component for a current activity;
displaying the components user interface for the current activity;
presenting instructions to the learner for the current activity;
tracking results of the current activity;
interacting with the component's interface;
evaluating the interactions;
updating at least one of the learner's progress and performance on the current activity;
providing feedback to the learner regarding at least one of the learner's progress and performance on the current activity;
determining if the learner has completed the current activity; and
sending results the learner's performance of the current activity to a database.

7. The method of claim 6, further comprising:
executing rules altering at least one of properties and flow of the sequence if the next node in the sequence is a rule set once results are sent.

8. The method of claim 7, further including:
loading a next learning activity if there is another learning activity in the sequence; and again performing the following:
loading a parent learning component for a current activity;
displaying the components user interface for the current activity;
presenting instructions to the learner for the current activity;
tracking results of the current activity;
interacting with the component's interface;
evaluating the interactions;
updating at least one of the learner's progress and performance on the current activity;
providing feedback to the learner regarding at least one of the learner's progress and performance on the current activity;
determining if the learner has completed the current activity; and
sending results the learner's performance of the current activity to a database.

9. The method of claim 6, further including:
once a learning activity is completed, determining if free play is permitted and if so, and allowing the learner to freely interact with related learning activities.

10. The method of claim 6, when the learner is determined to be struggling, further including:
placing the learner on a triage list; and
having the instructor contact the learner.

11. The method of claim 10, further including:
having the instructor remotely view the learner's screen.

12. The method of claim 10, further including:
preparing a subsequence for the learner.

13. The method of claim 12, further including:
injecting the subsequence to the learner.

14. The method of claim 13 further including:
send the learners results to a database.

15. A method of analyzing a sequence session comprising:
selecting a sequence session to analyze;
loading a results monitor on a computer;
retrieving learning components employed in the sequence;
loading all component monitors associated with the learning components;
loading a component monitor user interface;
displaying activity results collected by the learning activities; and
displaying a list of learners and comparing results associated with a learner.

16. The method of claim 15, further including:
searching a database for all component monitors associated with a learning component associated with the selected sequence.

17. The method of claim 15, further including:
exporting the results associated with learner.

18. The method of claim 15, further including:
loading data captured by the component's learning activities; and
displaying the user interface for the dataset specified by the component developer for the component monitor.

19. A learning component instruction development/design environment system comprising:
web servers operatively connected to communication and streaming media servers, application servers, a component and media repository and a database wherein the system is configured to:
launch learning components on a computer;
add a learner tracking strip to live monitor a learner;
notify an instructor that a learner is active;
load a learning activity in a sequence;
load a parent learning component for a current activity;
display the components user interface for the current activity;
present instructions to the learner for the current activity;
track results of the current activity;
interact with the component's interface;
evaluate the interactions;
update at least one of the learner's progress and performance on the current activity;
provide feedback to the learner regarding at least one of the learner's progress and performance on the current activity;
determine if the learner has completed the current activity; and
send results the learner's performance of the current activity to a database.

20. The system of claim 19 further configured to:
add a learning activity to the learning sequence;
arrange the learning activity in a sequence graph;
add rules to the sequence graph;
deploy the sequence; and
create a sequence session.
